(19) United States
(12) Patent Application Publication
(10) Pub. No.: US 2016/0007799 A1
(43) Pub. Date: Jan. 14, 2016

(54) APPARATUS, SYSTEM AND METHOD FOR A WAFFLE SANDWICH PRESS

(71) Applicant: Heartland Food Products, LLC, Westwood, KS (US)

(72) Inventor: William R. Steeb, Kansas City, MO (US)

(73) Assignee: Heartland Food Products, LLC

(21) Appl. No.: 14/793,791

(22) Filed: Jul. 8, 2015

Related U.S. Application Data
(60) Provisional application No. 62/022,375, filed on Jul. 9, 2014.

(51) Int. Cl. A47J 37/06; A21D 13/00

(52) U.S. Cl. CPC A47J 37/0611; A21D 13/0025

(57) ABSTRACT

An apparatus, system and method for a waffle sandwich press is described. A waffle sandwich press includes a pair of sandwich warming plates hingedly coupled together, wherein each sandwich warming plate includes a waffle mold, the waffle mold having a grid pattern including a set of ridges, each ridge in the set of ridges extending from a floor of each of the waffle molds, wherein the ridges interlock with a waffle having a waffle height, and the floor of each of the waffle molds is inset into one of the pair of sandwich warming plates a depth equal to at least 60% of the waffle height, and wherein a perimeter of the waffle mold formed in the first sandwich warming plate contacts a perimeter of the waffle mold formed in the second sandwich warming plate when the pair of sandwich warming plates are hinged closed.

### CROSS REFERENCE TO RELATED APPLICATIONS

This application claims the benefit of U.S. Provisional Application No. 62/022,375 to Steeb, filed Jul. 9, 2014 and entitled “WAFFLE PANINI PRESS AND METHOD.”

### BACKGROUND OF THE INVENTION

1. Field of the Invention

Embodiments of the invention described herein pertain to the field of toasted sandwich makers. More particularly, but not by way of limitation, one or more embodiments of the invention enable an apparatus, system and method for a waffle sandwich press.

2. Description of the Related Art

Many types of sandwiches are conventionally enjoyed warm. Typically the bread of a warmed sandwich is toasted golden brown, and filled with melted cheese or another meltable or gooey ingredient such as chocolate or yogurt. These warm, crispy, gooey sandwiches add to the enjoyment and taste of sandwiches. Warm sandwiches may be eaten for breakfast, lunch, dinner or any other time of day. Popular warm sandwiches include panini sandwiches, such as turkey pesto with mozzarella or steak and cheddar, deli sandwiches such as a Rueben, breakfast sandwiches such as egg, bacon and cheese, or desert sandwiches such as apple pie panini or French toast sandwiches with chocolate spread and jelly.

Warm sandwiches are sometimes made in a buttered pan and pressed down with a flat spatula or other weight such as a brick wrapped in foil. Toasted sandwich makers, also called sandwich presses or sandwich warming grills, are also conventionally used to make warm sandwiches. In the case of toasted sandwich makers, the cold sandwich is surrounded on the top and bottom by flat, heated grill plates. The heated plates are pressed together during the warming process to squeeze the sandwich. In either case, the pressure from the spatula, heated plate or other weight, in combination with heat from the stove or grill, toasts the sandwich bread and also melts and warms the sandwich stuffing.

Both heat and pressure are important in creating a proper toasted sandwich. The heat must be transferred through the sandwich bread in order to melt the sandwich filling. At the same time, the sandwich bread should become toasted, often to a light golden brown, without burning. For this reason, warm sandwiches typically have a smooshed, flatted or squashed appearance due to the heat and pressure from a grill plate, spatula or other weight. The flattened or “pressed” warm sandwich, although delicious in taste, is often unappetizing in appearance.

Another problem that arises with a “pressed” sandwich is that the pressure that is placed on the sandwich during the warming process often forces the sandwich filling out of the sandwich. Conventionally, a space remains between the heated grill plates of a toasted sandwich maker during the toasting process in order to allow sandwiches with thick fillings. As a result, a substantial portion of the filling often squirts out the sides of the sandwich as downward pressure is placed on the sandwich. Much of the filling is lost as it squirts out the edges of the sandwich, which is wasteful, and also creates a mess since the filling sticks to the heated grill plates or the counter.

In addition, because the warmed sandwich is pressed flat, the type of bread capable of being used whilst retaining its original, appealing appearance and texture is limited. Thick breads, soft bread, or breads with three-dimensional patterns on their surfaces become flattened and misshapen by the pressure and heat during the warming process. Sandwich consumers often desire additional bread options and sandwich combinations to increase eating enjoyment.

Some attempts have been made to improve the appearance of pressed warm sandwiches by branding “grill” marks, silly faces, or other designs into the surface of the sandwich bread during the pressing process. However, these attempts fail to maintain the original, appetizing appearance of the bread, particularly when the bread is formed into a unique three-dimensional shape prior to the pressing or warming process. There is a continuing commercial need for new and exciting warm sandwiches that are appetizing in appearance and provide additional bread options.

As is apparent from the above, conventional toasted sandwich makers suffer from several limitations, for example in the type of bread that may be employed in the sandwich, the appearance of the end product, and in retaining the filling. Therefore, there is a need for an apparatus, system and method for a waffle sandwich press.

### BRIEF SUMMARY OF THE INVENTION

One or more embodiments of the invention enable an apparatus, system and method for a waffle sandwich press.

An apparatus, system and method for a waffle sandwich press is described. An illustrative embodiment of a waffle sandwich press apparatus includes a waffle maker comprising a pair of baking plates, wherein the pair of baking plates together form an impression of a waffle determining a waffle height, a sandwich press including a first warming plate hingedly coupled to a second warming plate such that the first and second warming plates are moveable between an open preparatory position and a closed warming position, the first and second warming plates each comprising a warming surface, wherein the warming surfaces of each of the first and second warming plates comprises a baked waffle mold surrounded by a flat portion, wherein a floor of the baked waffled mold is inset from the flat portion a distance of at least 60% of the waffle height, and wherein the flat portion of the warming surface of the first warming plate contacts the flat portion of the warming surface of the second warming plate when each of the first and second warming plates contains a pre-baked waffle and the sandwich press is pressed into the closed warming position. In some embodiments, the floor of the baked waffle mold is inset from the flat portion a distance between 60% and 70% of the waffle height. In certain embodiments, the baked waffle mold forms a shape of one of a heart, an animal or a cartoon character. In some embodiments, the baked waffle mold includes ridges extending from a floor of the baked waffle mold and the ridges interlock with the pre-baked waffle.

An illustrative embodiment of a waffle sandwich press apparatus includes a pair of sandwich warming plates, wherein a first sandwich warming plate of the pair of sandwich warming plates is hingedly coupled to a second sandwich warming plate of the pair of sandwich warming plates, and wherein each sandwich warming plate include a waffle mold, the waffle mold having a grid pattern comprising a set of ridges, each ridge in the set of ridges extending from a floor of each of the waffle molds, wherein the ridges interlock with a waffle having a waffle height, and the floor of each of the waffle molds inset into one of the pair of sandwich warming plates a depth equal to at least 60% of the waffle height, and wherein a perimeter of the waffle mold formed in the first sandwich warming plate contacts a perimeter of the waffle mold formed in the second sandwich warming plate when the pair of sandwich warming plates are hinged closed. In some embodiments, the waffle mold forms the shape of a face and the ridges comprise facial features. In certain embodiments, the floor of each of the waffle molds is inset into one of the pair of sandwich warming plates a depth equal to between 60% and 70% of the waffle height. In some embodiments, the edges of the waffle are sealed when the sandwich warming plates are hinged closed.

An illustrative embodiment of a method of making a pressed waffle sandwich includes heating a waffle sandwich press, the waffle sandwich press including a bottom waffle mold formed in a bottom baked-waffle sandwich press plate, wherein a first depth of the bottom waffle mold is a least 60% of a first height of a first baked waffle, a top waffle mold formed in a top baked-waffle sandwich press plate, wherein a second depth of the top waffle mold is at least 60% of a second height of a second baked waffle, a hinge coupling the top waffle mold and the bottom waffle mold, placing the first baked waffle into the bottom waffle mold, setting a waffle sandwich filling on top of the first baked waffle, positioning the second baked waffle on top of the waffle sandwich filling, closing the top baked-waffle sandwich press plate such that the top waffle mold interlocks with the second baked waffle, pressing down on the top baked-waffle sandwich press plate such that a first flat portion of the top baked-waffle sandwich press plate and a second flat portion of the bottom baked-waffle sandwich press plate meet and at least 60% of a shape of each of the first and second baked waffle is preserved, wherein one of the heat, the pressure or a combination thereof seals an edge of the first baked waffle to an edge of the second baked waffle with the waffle sandwich filling therebetween, thereby forming a baked-waffle sandwich. In some embodiments, the second baked waffle is the same waffle as first baked waffle and the waffle is folded over. In certain embodiments, the waffle sandwich filling comprises a third baked waffle. In some embodiments, the waffle sandwich filling includes cheese and the cheese at least partially seals the edge of the first baked waffle to the edge of the second baked waffle when melted. In certain embodiments between 60% and 70% of the shape of each of the first and second baked waffle is preserved.

In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

The above and other aspects, features and advantages of illustrative embodiments of the invention will be more apparent from the following more particular description thereof, presented in conjunction with the following drawings wherein:

FIG. 1 is a perspective view of a waffle maker of an illustrative embodiment.

FIG. 2 is a cross sectional view across line 2-2 of FIG. 1 of a waffle maker of an illustrative embodiment.

FIG. 3 is a perspective view of a waffle maker of an illustrative embodiment in an open position.

FIG. 4 is a perspective view of an illustrative embodiment of a waffle maker with a baked waffle therein.

FIG. 5 is a perspective view of a baked waffle made using an illustrative embodiment.

FIG. 6 is a perspective view of a waffle sandwich press of an illustrative embodiment.

FIG. 7 is a cross sectional view across line 7-7 of FIG. 6 of a sandwich press of an illustrative embodiment.

FIG. 8 is a perspective view of a waffle sandwich press of an illustrative embodiment in an open position.

FIG. 9 is a top plan view of a waffle sandwich press of an illustrative embodiment in an open position.

FIG. 10 is a perspective view of a warming plate of an illustrative embodiment.

FIG. 11 is a perspective view of a warming plate of an illustrative embodiment with a baked waffle placed therein.

FIG. 12 is a perspective view of a waffle sandwich press of an illustrative embodiment illustrating the placement of sandwich ingredients within the waffle sandwich press.

FIG. 13 is a perspective view of a waffle sandwich press of an illustrative embodiment in an open position and containing sandwich ingredients prior to pressing.

FIG. 14 is a cross sectional view of a waffle sandwich press of an illustrative embodiment in a closed position and containing sandwich ingredients.

FIG. 15 is a perspective view of an illustrative embodiment of pressed waffle sandwich with sealed edges.

FIG. 16 is a perspective view of a pressed waffle sandwich cut in half that was made using an illustrative embodiment.

FIG. 17 is a top plan view of a waffle sandwich press system of illustrative embodiments.

FIG. 18A is a perspective view of an exemplary warming plate of an illustrative embodiment with a baked waffle placed therein.

FIG. 18B is a perspective view of an exemplary warming plate of an illustrative embodiment with a baked waffle placed therein.

FIG. 18C is a perspective view of an exemplary warming plate of an illustrative embodiment with a baked waffle placed therein.

FIG. 18D is a perspective view of an exemplary warming plate of an illustrative embodiment with a baked waffle placed therein.

While the invention is susceptible to various modifications and alternative forms, specific embodiments thereof are shown by way of example in the drawings and may herein be described in detail. The drawings may not be to scale. It should be understood, however, that the embodiments described herein and shown in the drawings are not intended to limit the invention to the particular form disclosed, but on the contrary, the intention is to cover all modifications, equivalents and alternatives to such embodiments that fall within the scope of the present invention as defined by the appended claims.

### DETAILED DESCRIPTION

An apparatus, system and method for a waffle sandwich press will now be described. In the following exemplary description, numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

As used in this specification and the appended claims, the singular forms “a”, “an” and “the” include plural referents unless the context clearly dictates otherwise. Thus, for example, reference to an edge includes one or more edges.

“Coupled” refers to either a direct connection or an indirect connection (e.g., at least one intervening connection) between one or more objects or components. The phrase “directly attached” means a direct connection between objects or components.

As used herein, the term “bread” means the edible, outer wrapper of a sandwich used to hold the sandwich filling. As used herein, “bread” may refer by example and without limitation to sliced bread such as for example white, whole-wheat, rye or sour-dough, bread from a loaf, rolls, ciabatta, baguette, croissant, pancakes, tortillas, buns, dessert breads, French toast, cake, biscuits and waffles.

As used herein, the term “sandwich” refers to any edible food product including bread and filling. As used herein, a “sandwich” includes a single piece of bread or bread item wrapped around a filling, such as a quesadilla, burrito or pita, as well as two or more pieces or slices of bread or bread items with a filling in between.

As used herein, the term “waffle” means a particular type of bread that has been cooked in a mold having a raised or depressed design so arranged as to form a corresponding three-dimensional design on the bread. As used herein, a “waffle” includes without limitation the well-recognized square or diamond pocket pattern of a traditional waffle, honeycomb patterns, breads formed in the shape of a well-known cartoon character such as the head of Mickey Mouse and other three-dimensional patterns and shapes. As used herein, a “waffle” excludes bread only having patterns or designs placed onto the bread after it has been cooked, such as grill marks or brands added to the bread's surface after the bread has already been baked.

As used herein, the “outer surface” of a waffle in a waffle sandwich means, with respect to same waffle, the surface of the waffle that is opposite and substantially parallel to the surface touching the filling.

As used herein, a “seal” means, in two waffle embodiments, that the edges of the top and bottom waffles substantially stick together around their perimeters and/or circumferences.

Illustrative embodiments provide an apparatus, system and method for a waffle sandwich press. While for ease of description and so as not to obscure the invention, illustrative embodiments are described in terms of a pressed waffle sandwich, nothing herein is intended to limit the invention to that embodiment.

Illustrative embodiments provide a waffle sandwich press that allows a warm and/or toasted, pressed sandwich to be made using waffles as the bread of the sandwich. The waffle sandwich press of illustrative embodiments may preserve the three-dimensional shape on the top and bottom outer surface of the waffle “bread” despite applied pressure during the warming and/or pressing process. Illustrative embodiments may crisp the waffle, retain the waffle shape on the outer surfaces of the waffles, and seal the edges of the waffle sandwich so that warm, gooey and/or melty filling is retained inside the sandwich when the sandwich is pressed and heated.

Illustrative embodiments provide a baked-waffle sandwich press that may include opposing warming plates coupled together by a hinge and/or pivot. Each of the warming plates may include a waffle mold surrounded by a flat portion. The waffle mold of each of the warming plates may be shaped in the mirror-image of a particular baked waffle, with the waffle mold inset below the flat portion of the warming plate. When a baked waffle is placed in the warming plate, at least 60% of the baked waffle by height and/or volume may sit below the plane of the flat portion. The flat portion of the warming plates may face each other and touch when the waffle sandwich press is closed and/or in the pressed position. If the waffle sandwich press is empty, when closed, the warming plates may touch each other without the need for applied pressure on the plates. When a baked waffle is placed in the waffle mold of each of the opposing warming plates, and a filling placed therebetween, pressure on the waffle sandwich press in the closed position, applied by a human operator, may cause the flat portion of the warming plates and/or the edges of the waffle molds to touch. The heat and/or pressure may seal the edges of the waffle sandwich such that the filling remains inside during the heating process. The waffle sandwich press of illustrative embodiments may toast and/or crisp the outer surfaces of the waffle “bread” while retaining the waffle shape on those outer surfaces, melt the sandwich filling, and seal the edges of the pressed, warm sandwich, and thereby may create, an appealing, pressed waffle sandwich.

For ease of illustration, the opposing warming plates of the waffle sandwich press and/or the baking plates of the waffle maker of illustrative embodiments are sometimes referred to herein as “top” and “bottom” warming plates or baking plates, as applicable. However, the orientation of the plates may rotate causing the “top” plate to become the “bottom” plate and vice versa. For example, in some embodiments, rotation of the waffle baker or sandwich press may begin the baking or pressing timer and/or allow the waffle batter to spread out evenly in the case of baking plates. In addition, it is also contemplated that the warming plates may be oriented sideways.

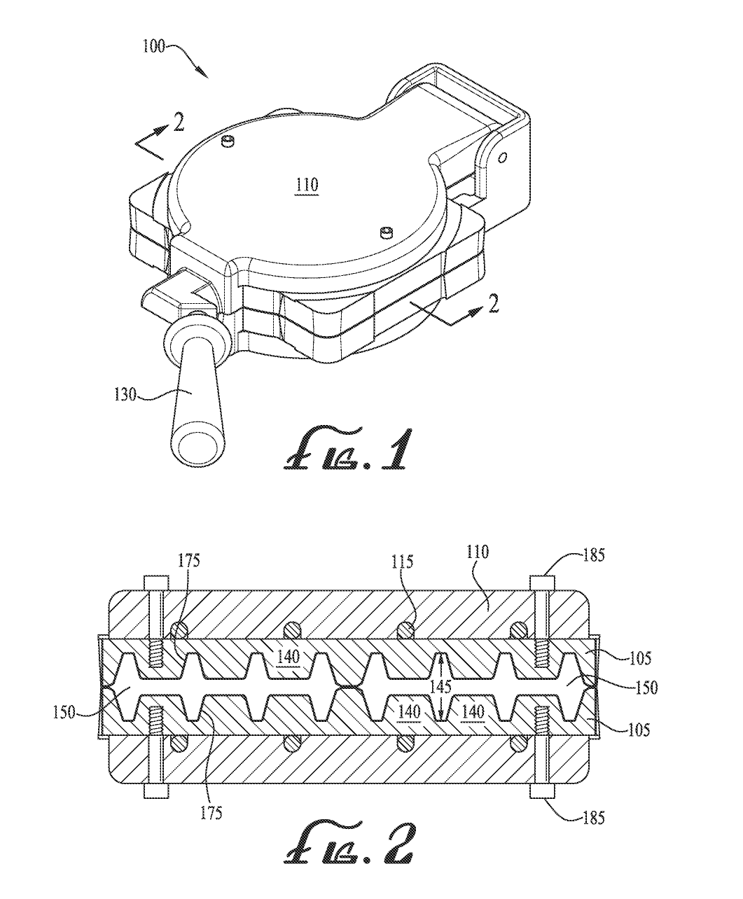

Illustrative embodiments include a waffle sandwich press that has waffle molds for a particular shape of baked waffle. The baked waffle of illustrative embodiments may be made from batter and cooked and/or baked in a waffle maker with baking plates formed to create the desired waffle design. The batter may be any type of waffle batter well known to those of skill in the art, for example a semiliquid mixture of flour, egg and milk or water. The batter may be whole grain, gluten-free and/or contain flavorings such as chocolate or cinnamon. The baking plate design creates a baked waffle in mirror-image of the baking plates. An exemplary waffle maker is illustrated in FIGS. 1-3. Waffle maker 100 may be sized similarly to other small, countertop kitchen appliances (e.g., coffee makers, toaster ovens, etc.), such as in one example between 1 and 3 pounds and between 8 inches and 15 inches in length.

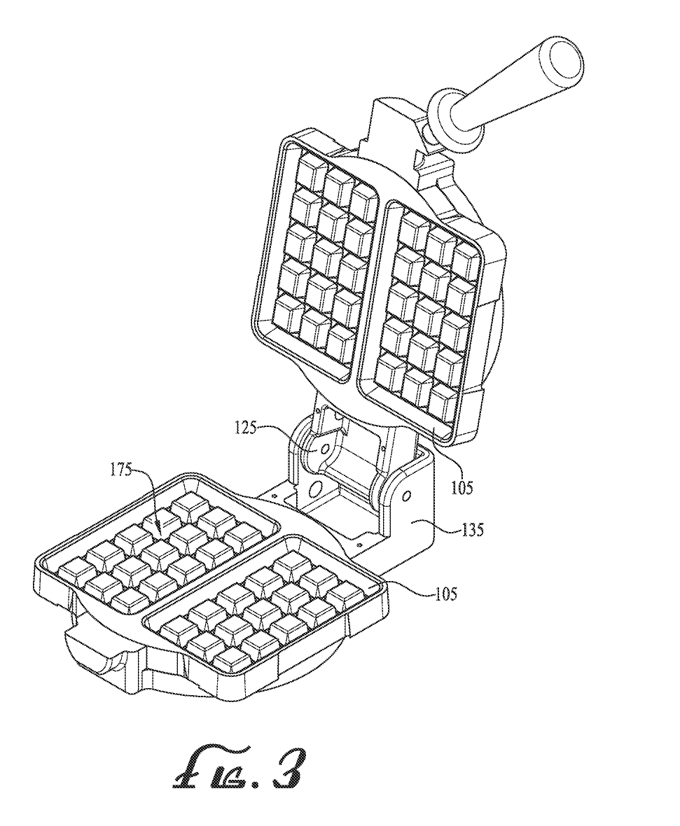

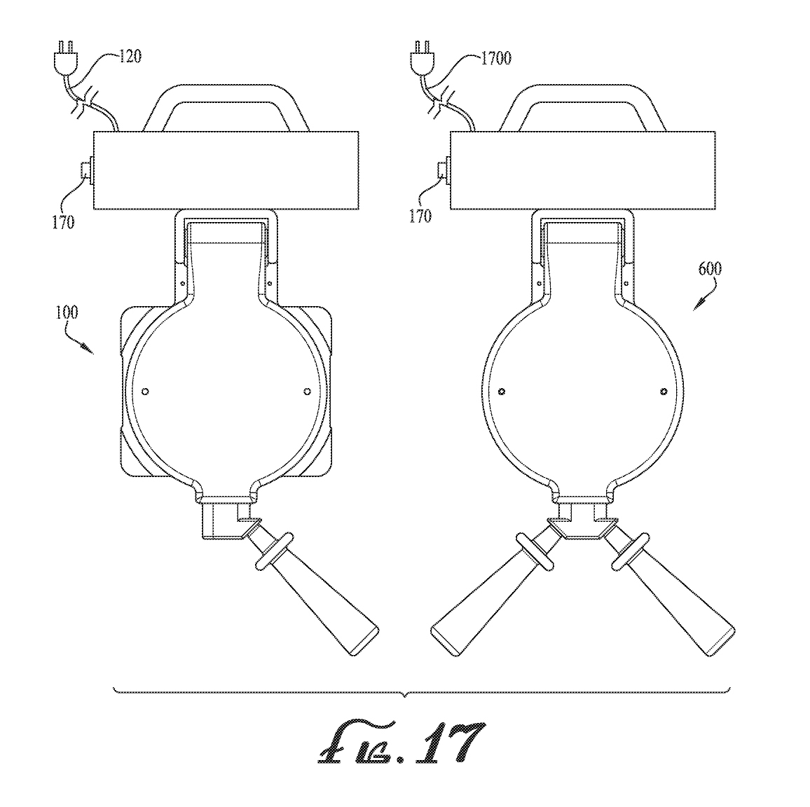

As shown in FIG. 2 and FIG. 3, waffle maker 100 may include baking plates 105 secured within housing 110 by screws 185, which may be socket cap screws, hex head screws or another attachment mechanism. Housing 110 and/or baking plates 105 may include resistive maker heating element 115 such as a Calrod or heating element wire. Activation of maker heating element 115 may cause baking plates 105 to become hot. Waffle maker 100 may be connected to a power source, such as an electric wall outlet by waffle maker cord 120 (shown in FIG. 17).

Top baking plate 105 and/or top housing 110 may be connected to bottom baking plate 105 and/or bottom housing 110 by maker hinge 125 supported by frame 135 such that waffle maker 100 may be opened as shown in FIG. 3, or closed as shown in FIG. 1 and FIG. 2. In one example, maker hinge 125 may be connected to housing 110, while baking plates 105 may be attached to housing 110. Maker hinge 125 may be a ball, acorn, button, clows, finger, scissor, cylinder, floating or any other hinge design known to those of skill in the art. Maker handle 130 may be insulated and/or include a heat-resistant grip and allow an operator to open and close waffle maker 100 without burning his or her hand. Waffle maker 100 may also include a temperature gauge, temperature setting control 170 (shown in FIG. 17) and/or timer as is well known to those of skill in the art. In one example, waffle maker 100 may include “light” and “dark” settings and/or a temperature baking range of about 300° F. to 400° F. and take between about 1 minute and 4 minutes to cook a waffle once batter is poured onto a heated baking plate 105. In one example, a waffle may bake at 325° F. for two-and-one-half minutes.

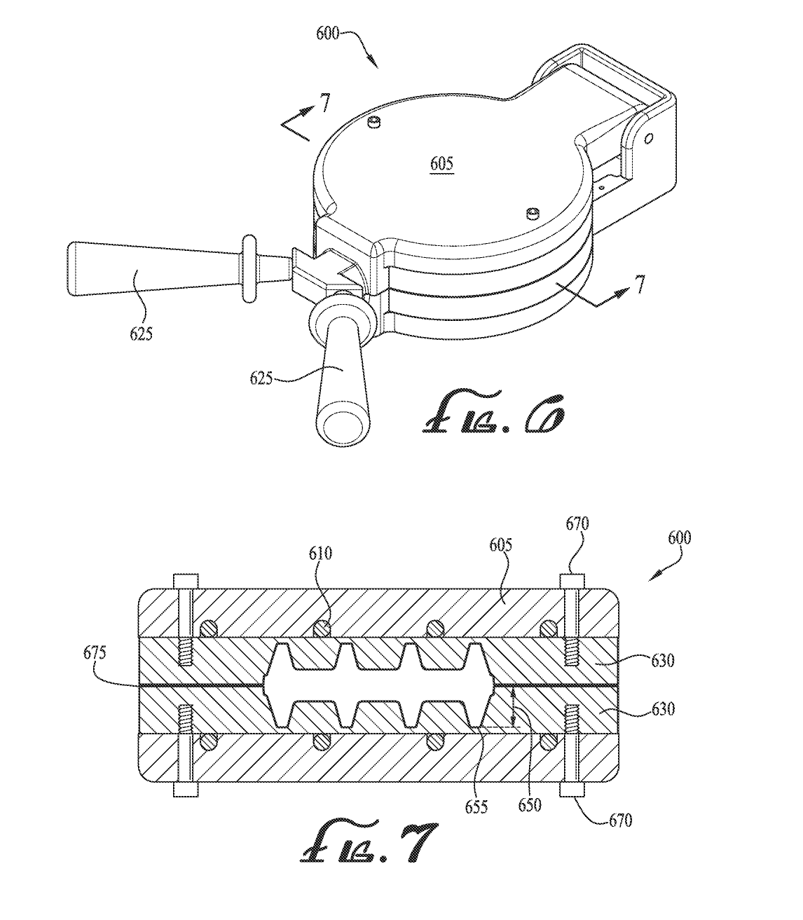

Waffle baking plates 105 may mold waffle batter into the desired waffle shape to create waffle 200, for example as shown in FIG. 5. Waffle maker 100 may create one, two or more waffles 200 at one time. In two waffle 200 embodiments, the waffles 200 such as for the top and bottom bread of a pressed waffle sandwich 300 may be identically shaped to one another, or may vary in shape from each other, for example one waffle 200 may have differently shaped pockets 180 or a different pocket 180 distribution from the other. As shown in FIG. 2 and FIG. 3, waffle maker 100 may create two waffles at a time, for example to create two waffles for a waffle sandwich. Waffle baking plates 105 may each include template 175. Each template 175 may form half of a waffle 200, such as a top half or bottom half of waffle 200.

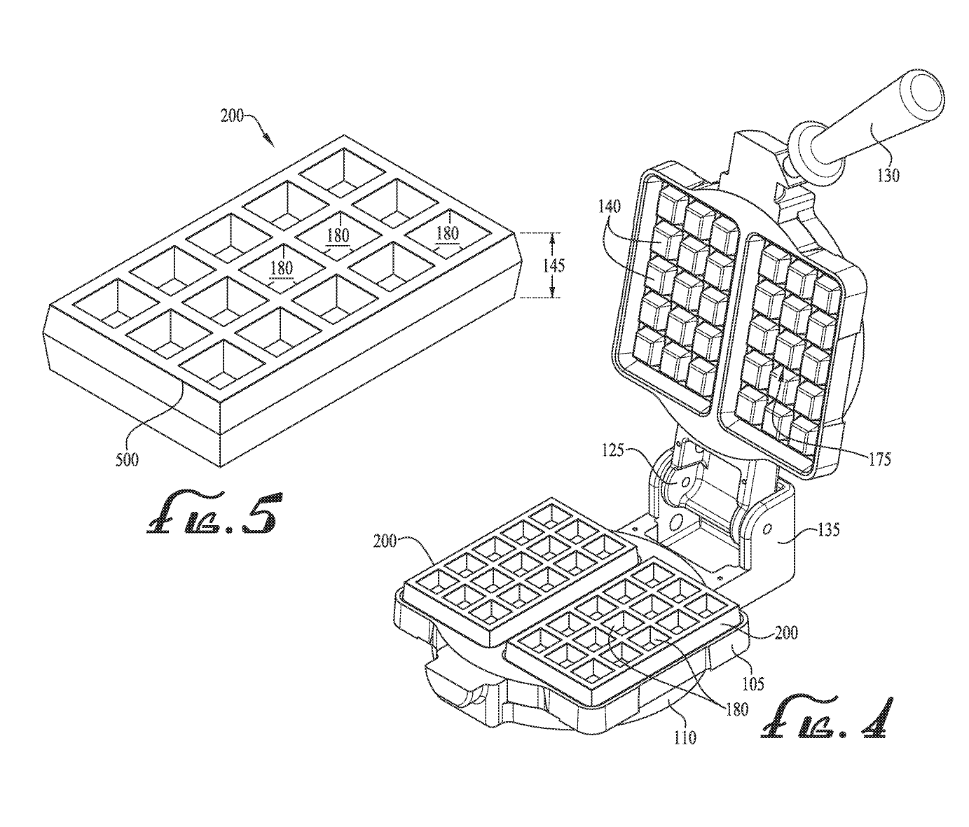

FIG. 4 illustrates a baked waffle 200 as molded by waffle maker 100. As shown in FIG. 4, bottom baking plate 105 forms the bottom half of baked waffle 200. Top baking plate 105 forms the top half of baked waffle 200. In FIG. 4, waffle maker 100 is shown open to illustrate the relationship between the dimensions of waffle 200 and waffle baking plates 105. As illustrated in FIG. 4, waffle 200 is the mirror image of template 175 and each template 175 creates half of each waffle 200. In the embodiment shown in FIG. 4, two identical waffles 200 have been baked by waffle maker 100.

Returning to FIG. 2, when waffle baking plates 105 are closed, top and bottom templates 175 form a cavity 150 in the shape of waffle 200. In the example of FIG. 2, since two waffles 200 are made simultaneously, two cavities 150 are shown. The perimeter of templates 175 may be any desired shape, such as a square, rectangle, circle, quadrant of a circle, cartoon character shaped, or any other imaginative design capable of being held by waffle 200. The waffle maker 100 of FIG. 4 bakes two waffles 200 with a rectangular shaped perimeter 500 (shown in FIG. 5).

Apart from the shape of the perimeter 500 of waffle 200 (e.g., a square, circle, heart, or profile of President Washington, for example), waffle 200 may include a three dimensional design. In the example of FIGS. 3 and 4, templates 175 create a Belgian waffle design characterized by a grid pattern of pockets 180. To create the pattern of pockets 180, templates 175 include rows and columns of ridges 140. When waffle maker 100 is closed as shown in FIG. 2, in the example of FIG. 2, the ridges 140 of the top template 175 align with the ridges 140 of the bottom template 175. When batter is poured onto heated templates 175, the batter may fill cavity 150 and solidify and/or bake into waffle 200 having the shape of cavity 150. Each ridge 140 creates pocket 180 in waffle 200 and the height of waffle 200 is waffle height 145 as illustrated in FIG. 2 and FIG. 5. Although waffle 200 may include portions with a height less than waffle height 145, for example in areas of a pocket 180 depression, waffle height 145 may represent the boundaries of the three-dimensional design of waffle 200 and/or the apparent shape of the outer surface to be substantially preserved during pressing. As illustrated in FIG. 4, each template 175 may create half of waffle 200.

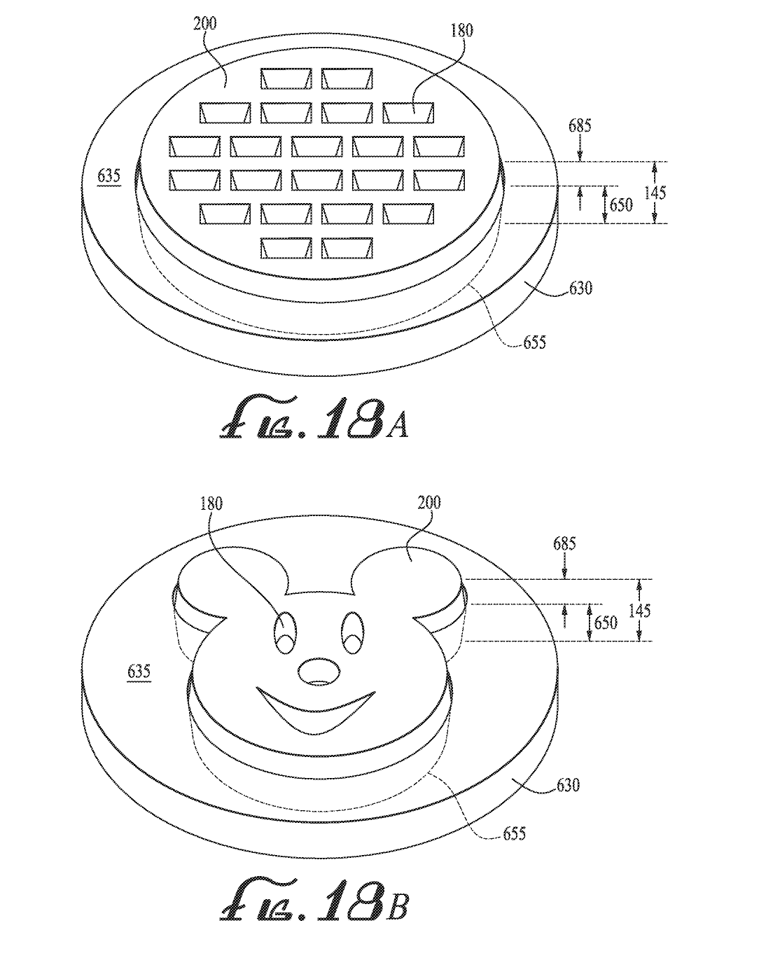

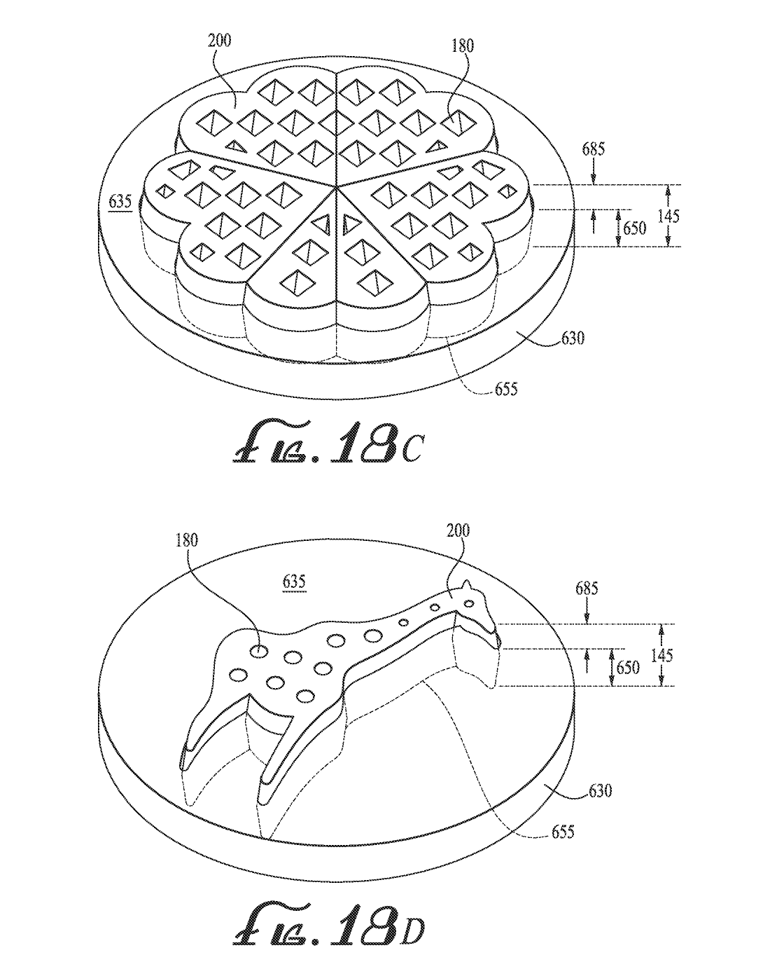

FIG. 5 shows an illustrative embodiment of waffle 200 baked by waffle maker 100. As shown in FIG. 5, waffle 200 has a height 145, perimeter 500 that is rectangular in shape and a three-dimensional waffle pattern of depressions and protrusions, in the case of FIG. 5 pockets 180. As one of skill in the art will appreciate, although a Belgian waffle pattern is shown as a rectangular waffle in the example of FIG. 5, other patterns, designs and/or shapes are contemplated herein. FIGS. 18A-18D illustrate a few exemplary additional possibilities for waffle 200 shape of illustrative embodiments. FIG. 18A illustrates a round waffle 200 with pockets 180. FIG. 18B illustrates a cartoon embodiment with pockets 180 in the shape of facial features. FIG. 18C illustrates flower or heart-shaped waffles 200. FIG. 18D illustrates a giraffe-shaped waffle 200 with pockets 180 shaped as spots.

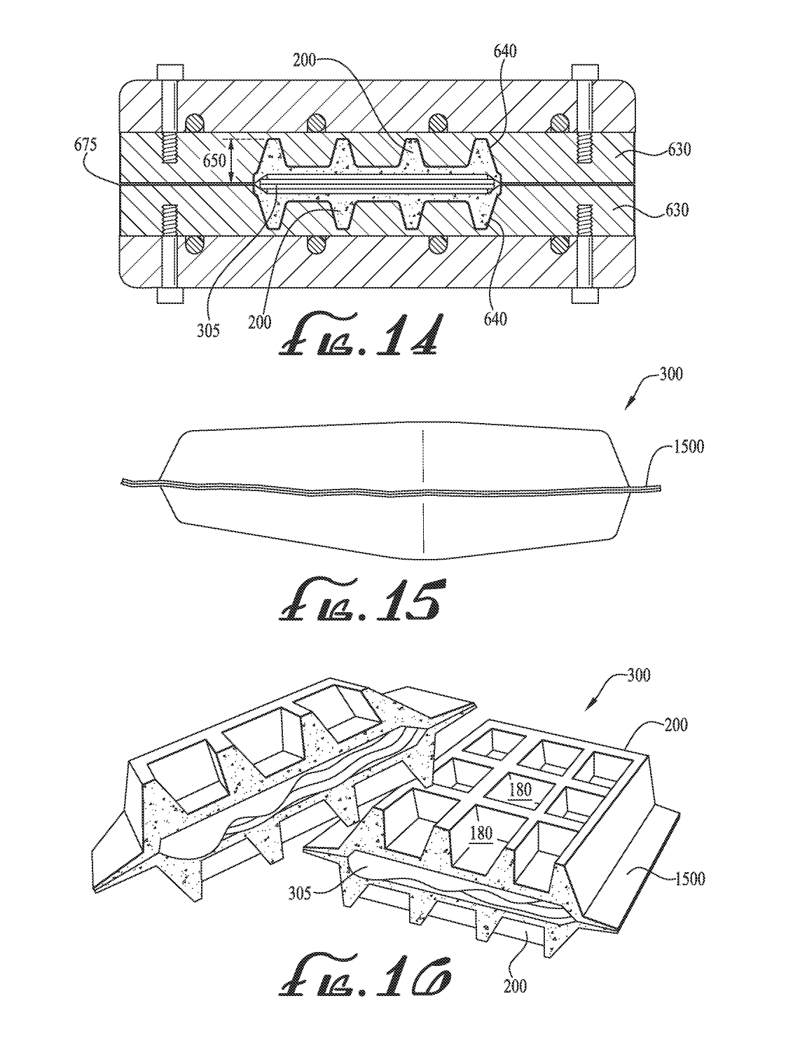

In illustrative embodiments, waffles 200 may be used as bread of a warm, pressed waffle sandwich such as pressed waffle sandwich 300 illustrated in FIGS. 15 and 16. In the embodiment illustrated in FIG. 16, prepared pressed waffle sandwich 300 includes two waffles 200 and a filling 305. Filling 305 may be meat, cheese, vegetables, chocolate, fruit and/or any other edible sandwich filling. Filling 305 may be in the form of slices as is typical in sandwiches, and although filing 305 may vary in thickness, the thickness of filing 305 may be reasonably sized to allow a sandwich consumer to bite through the thickness of pressed waffle sandwich 300. Although a waffle sandwich having two waffles 200 is shown in FIG. 16, pressed waffle sandwich 300 may also be made of a single waffle wrapped around filling 305 in a burrito or pita style, three waffles 200 may be layered in a club-style type sandwich, or pressed waffle sandwich 300 may be another similar waffle sandwich variant.

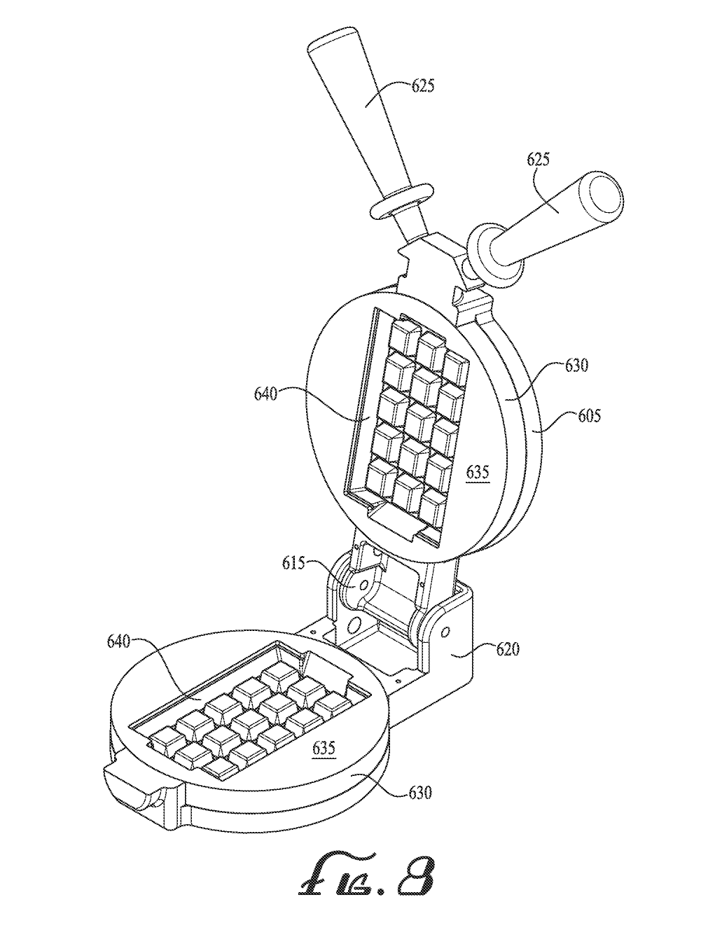

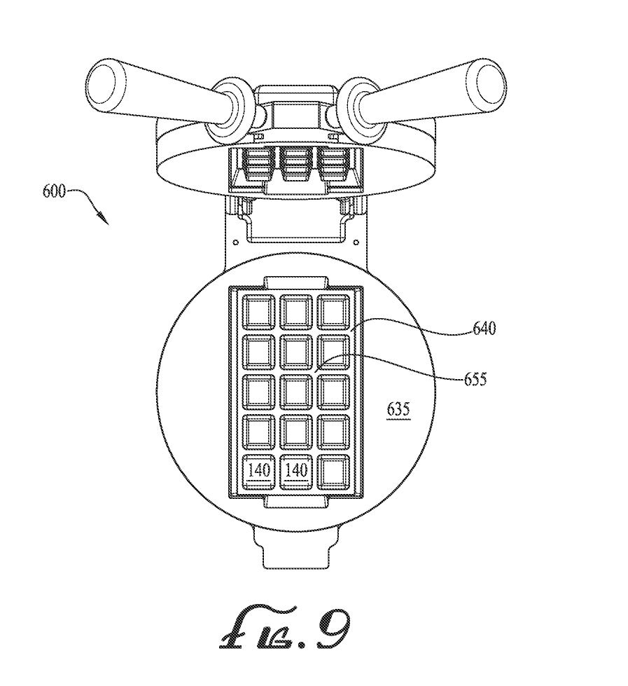

To prepare pressed waffle sandwich 300, once waffles 200 have been baked, waffles 200 may be placed in a waffle sandwich press of illustrative embodiments, along with filing 305, in order to press, crisp, brown, warm and/or seal pressed waffle sandwich 300. FIGS. 6-9 illustrate an exemplary waffle sandwich press 600. Similar in size to waffle maker 100, waffle sandwich press 600 may be a small kitchen appliance suitable for use on a kitchen countertop. Waffle sandwich press 600 may include carrier 605, which may be attached to warming plates 630 with attachment member 670, which attachment member 670 may be socket cap screws, hex head screws or another attachment mechanism, and contain press heating element 610. Press heating element 610 may be a resistive heating element such as heating element wire or a Calrod. Waffle sandwich press 600 may obtain power from a power source through press cord 1700 (shown in FIG. 17). Press cord 1700 of waffle sandwich press 600 may be its own dedicated power chord or may be shared with waffle maker chord 120 used for waffle maker 100. Activation of press heating element 610 may cause warming plates 630 to become hot.

In the embodiment of FIGS. 6-9, carrier 605 is a clam-shell casing that opens and closes about press hinge 615 on base 620. Press hinge 615 may be a ball, acorn, button, clows, finger, scissor, cylinder, floating or any other hinge design known to those of skill in the art. Waffle sandwich press 600 may include handles 625, which may be insulated and/or include a heat-resistant grip, and may be designed such that an operator may press down evenly on both sides of waffle sandwich press 600 during the pressing process. Waffle sandwich press 600 may include two opposing warming plates 630 that face each other, which when hinged and/or pivoted closed may be oriented on top of one another such that the top warming plate 630 may be pressed towards bottom warming plate 630. Interface 675 illustrates the manner in which flat portion 635 of top and bottom warming plates 630 touch and lay flush against one another when waffle sandwich press 600 is closed and/or in the press position. Interface 675 may cause the perimeter 500 of waffle 200 in top warming plate 630 to touch the perimeter 500 of waffle 200 in bottom warming plate 630. Press heating element 610 may heat warming plates to between about 350° F. and 400° F. In one example, a waffle sandwich 300 may be pressed at 390° F. for about 90 seconds. Warming plates 630 may be cast metal such as stainless steel, iron or aluminum and/or may include a non-stick coating such as Teflon.

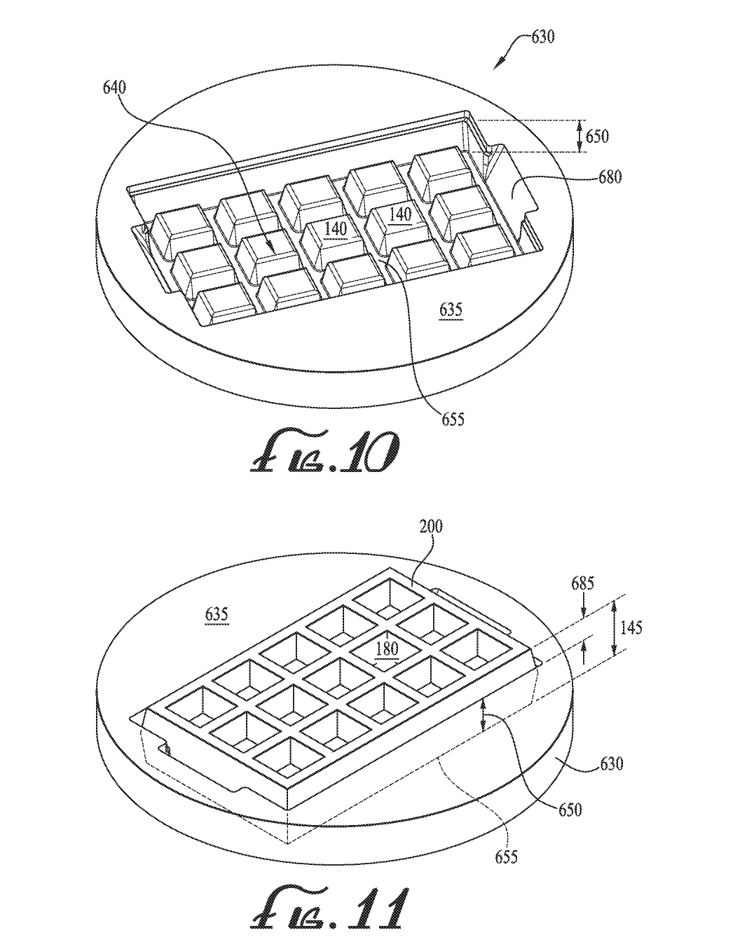

Warming plates 630 may include a flat portion 635 that surrounds a waffle mold 640. Waffle mold 640 may be recessed below the plane of flat portion 635. The perimeter of waffle mold 640 may be shaped to match the perimeter of waffle 200. As shown in FIGS. 10 and 11, waffle mold 640 is sized such that waffle 200 fits snugly inside waffle mold 640 and the perimeter of waffle mold 640 follows the perimeter of waffle 200 (although waffle mold 640 may also include slot 680 for easy removal of a pressed waffle sandwich 300). The waffle molds 640 of waffle sandwich press 600 of illustrative embodiments may mirror, correspond, trace, be the inverse of and/or follow the structure of baked waffle 200 so as to interlock with, support and/or maintain the particular shape of waffle 200 when pressure is placed on waffle 200. As shown in FIGS. 10 and 11, waffle mold 640 includes the same ridges 140 of waffle maker 100, which ridges 140 may be the same size and height as those of baking plates 105 and correspond in mirror-image to the pockets 180 of waffle 200. When baked waffle 200 is placed into waffle mold 640, as shown in FIG. 10, ridges 140 may support the shape of the waffle pockets 180 of waffle 200 even when moderate pressure is placed on waffle 200, such as the pressure required to make a pressed sandwich. Baked waffle 200 may interlock with waffle mold 640 like a puzzle piece.

Waffle molds 640 including the ridges 140 that reflect the desired waffle design may be recessed below flat portion 635 and/or inset into warming plate 630, as shown in FIGS. 10 and 11. Waffle mold 640 may be recessed as illustrated by recession 650 such that at least 55% and/or at least 60% of waffle height 145 sits below flat portion 635 when waffle 200 is placed inside waffle mold 640. Recession 650 may extend from floor 655 of waffle mold 640 to the plane of flat portion 635. The amount of recession 650 may vary depending on the shape and/or uniformity of waffle 200 but in illustrative embodiments more than half of waffle 200, either measured by waffle height 145 (thickness), volume of waffle 200 or both should be recessed below flat portion 635. FIG. 11 illustrates waffle 200 inside waffle mold 640 of warming plate 630. As shown in FIG. 11, about 60% of waffle height 145 is inset below flat portion 635, the portion enveloped into recession 650. Protruding portion 685, about 40% of waffle height 145 or less, extends above the plane of flat portion 635. As would be appreciated by one of skill in the art, although baking plates 105 and waffle mold 640 may include the same pattern of ridges 140 or other three-dimensional design, baking plates 105 may not be used as waffle mold 640, since the baking plates 105 necessary to create half of waffle 200 do not include recession 650 and therefore may not be structured to substantially preserve the form of outer surface of baked waffle 200 under pressure and/or heat.

Illustrative embodiments include a method of making a sealed, warm pressed sandwich. The edges 1500 (shown in FIG. 15) around perimeter 500 of pressed waffle sandwich 300 may be sealed in illustrative embodiments such that filling 305 does not substantially leak out of pressed waffle sandwich 300 during the pressing process. The sealing may not be a perfect seal, and some filling 305 may ooze outside the edges of pressed waffle sandwich 300, but the majority of filling 305 may remain inside pressed waffle sandwich 300.

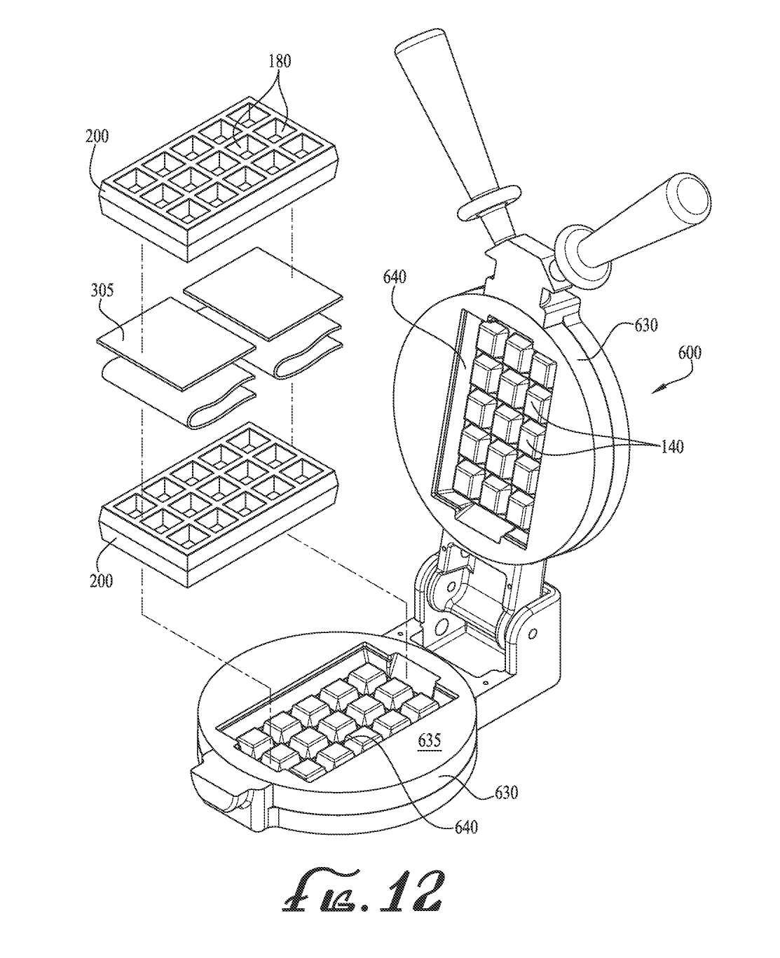

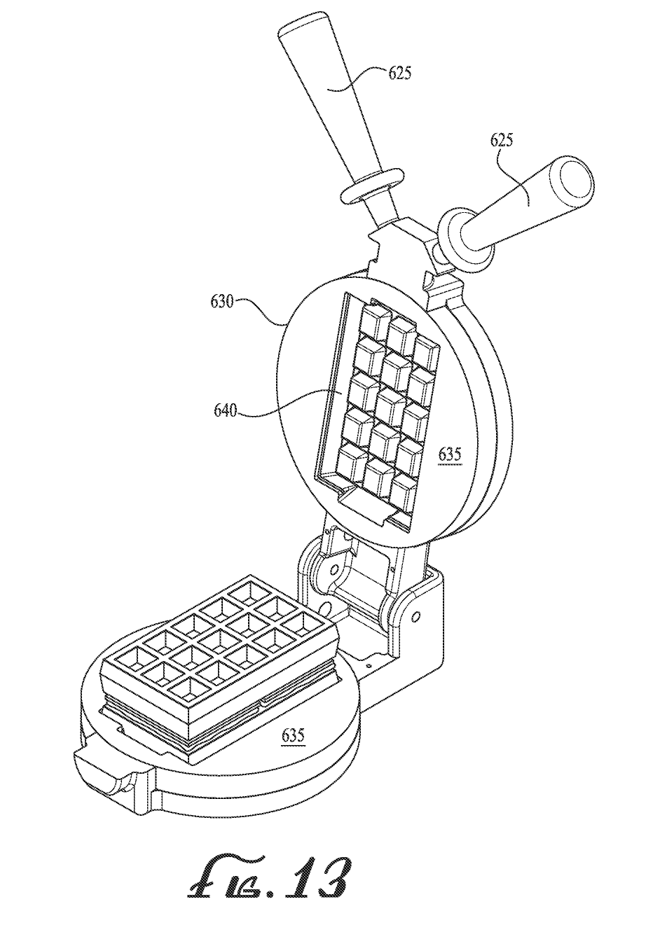

As illustrated in FIG. 12, the ingredients of waffle sandwich 300 may be layered into a pre-heated waffle sandwich press 600. A first waffle 200 may first be placed into bottom warming plate 630 such that it fits within and/or interlocks with waffle mold 640 of bottom warming plate 630 as described herein. When baked waffle 200 is placed within waffle mold 640, at least 60% of waffle 200 may be recessed below flat portion 635. In some embodiments about 55%, 60%, 62%, or 70% of waffle height 145 is in recession 650 below flat portion 635. Filling 305 may then be placed on top of first waffle 200. Second waffle 200 may then be placed on top of filling 305 and arranged such that pockets 180 in second waffle 200 line up with ridges 140 in waffle mold 640 of top warming plate 630. FIG. 13 illustrates the sandwich ingredients inserted on bottom warming plate 630 and ready to be pressed. An operator may then press handles 625 of the warm waffle sandwich press 600 and close waffle sandwich press 600 such that the top warming plate 630 closes over the sandwich ingredients and the top waffle mold 640 interlocks with top waffle 200. The operator may then press down on press handles 625 until the flat portion 635 of bottom warming plate 630 touches the flat portion 635 of top warming plate 630 such that interface 675 is achieved and/or the warming plates 630 are in the closed and/or warming position as illustrated in FIG. 14. Interface 675 may cause the perimeter 500 of waffle 200 in top warming plate 630 to touch the perimeter 500 of waffle 200 in bottom warming plate 630 to contact one another. The operator may hold and or press the plates in the warming position for one minute, ninety seconds, two minutes, two-and-a-half minutes or another similar amount of time to crisp and/or brown the waffles, melt any melatable filling if any, and/or seal the edges 1500 of the waffles 200 together. In some embodiments, once placed in the warming position, waffle sandwich press 600 may remain in the warming position without the need for additional pressure by the operator. As shown in FIG. 14, the portion of waffles 200 surrounded by and/or inserted into recession 650 (at least 60% of each waffle by height) may retain their original shape throughout and after the pressing process. As a result, the pocket 180 pattern on the outer surface of each of the waffles 200 may be preserved even when the sandwich is pressed.

FIG. 14 illustrates a waffle sandwich press 600, with sandwich ingredients inside, while in a closed, warming, toasting and/or pressing position. As illustrated in FIG. 14, warming plates 630 are closed and facing each other. Waffle molds 640 follow the shape of baked waffles 200, with filling 305 therebetween. Although a portion of waffles 200 facing filling 305 (protruding portion 685) may retract or flatten, the portion of waffles 200 inside recession 650 may maintain the desired baked waffle shape. The flat portions 635 of warming plates 630 may be flush against each other at interface 675. The edges 1500 of waffles 200 may be sealed around the perimeter 500 of waffles 200 to hold filling 305 inside warm, pressed waffle sandwich 300. FIG. 15 illustrates sealed edges 1500 of illustrative embodiments. As shown in FIG. 16, pressed waffle sandwich 300 retains the pattern of pockets 180 on the outer surface of each waffle 200, and in the example of FIG. 16, waffles 200 substantially retain their rectangular shape (although with pressed edges 1500).

For ease of illustration, the aforementioned examples have been with respect to a rectangular waffle in a Belgian waffle shape. FIGS. 18A-18D show illustrative examples of other shapes of waffles 200 and/or pockets 180. As shown in FIGS. 18A-18D, baked waffles 200 are inserted in warming plates 630, with at least 60% of their height 145 recessed into recession 650. As is appreciated by those of skill in the art, a variety of waffle shapes may be baked and implemented in a pressed waffle sandwich 300 of illustrative embodiments. As shown in FIG. 18A-18D, waffle 200 and the corresponding warming plates 630 may be round and pocketed as in FIG. 18A, flower or heart-shaped and pocketed as in FIG. 18C or may be in the shape of a cartoon character as in FIG. 18B. In the example of a cartoon character, pockets 180 may be shaped as facial features or other three dimensional designs. In the example of facial features, ridges 140 may be shaped in the mirror image and/or inverse of the desired features to be displayed on waffle 200.

As may be appreciated, the two outer surfaces of pressed waffle sandwich 300, formed for example from two waffles 200, may include designs that are identical to one another to create a symmetric sandwich, or the outer surfaces may include different designs from one another in order to create additional appearance options for pressed waffle sandwich 300. For example, to create a sandwich with a distinct front and back, in two waffle 200 embodiments, each waffle 200 that acts as the sandwich bread may include a different pattern of pockets 180. In one example, one outer surface of pressed waffle sandwich 300 may include a silly face (such as an eyes, nose and mouth) and a second outer surface may include a pocket pattern that resembles a hairdo, the back of the silly face's head or a tail. In such an example, baking plates 105 and/or template 175 for a first waffle 200, as well as top warming plate 630 and/or top waffle mold 640, may include a mirror image and/or the inverse of the silly face, whilst baking plates 105 and/or template 175 for a second waffle 200, as well as bottom warming plate 630 and/or bottom waffle mold 640, may include a mirror image and/or the inverse of the back of the silly face's head.

FIG. 17 illustrates a warm, pressed waffle sandwich making system of illustrative embodiments. As illustrated in FIG. 17, waffle maker 100 and waffle sandwich press 600 may work together as a set to bake waffles 200 of a particular shape and then make pressed waffle sandwiches 300 out of the desired waffle shape in succession. In some embodiments, baking plates 105 and warming plates 630 may be removeable from carrier 605 and/or housing 110 and only one machine may be necessary. However in commercial settings such as restaurants, hotels or motels, use of two distinct waffle maker 100 and waffle sandwich press 600 machines may be desirable in order to streamline and/or simplify the sandwich making process and/or in order to fine tune the heating, pressing and timing elements to best serve their specific functions.

Illustrative embodiments of an apparatus, system and method for a waffle sandwich press have been described. In illustrative embodiments, one or more waffles 200 having a particular three-dimensional shape may be used as bread in a warm, pressed sandwich. The three-dimensional shape on the outer surface of the waffles 200 may be preserved despite being heated and pressed. During pressing and heating, the edges 1500 of pressed waffle sandwich 300 may be sealed to retain sandwich filling 305 inside pressed waffle sandwich 300, and the waffle may become brown and crisp. Thus, a warm, pressed waffle sandwich that may be appealing and not “smooshed” in appearance may be made using illustrative embodiments.

While the invention herein disclosed has been described by means of specific embodiments and applications thereof, numerous modifications and variations could be made thereto by those skilled in the art without departing from the scope of the invention set forth in the claims. The embodiments described above are therefore considered in all respects to be illustrative and not restrictive. The scope of the invention is indicated by the appended claims, and all changes that come within the scope and range of equivalents thereof are intended to be embraced therein.

What is claimed is:

1. A waffle sandwich press apparatus comprising:
a waffle maker comprising a pair of baking plates, wherein the pair of baking plates together form an impression of a waffle determining a waffle height;
a sandwich press comprising:
a first warming plate hingedly coupled to a second warming plate such that the first and second warming plates are moveable between an open preparatory position and a closed warming position;
the first and second warming plates each comprising a warming surface, wherein the warming surfaces of each of the first and second warming plates comprises a baked waffle mold surrounded by a flat portion, wherein a floor of the baked waffled mold is inset from the flat portion a distance of at least 60% of the waffle height; and
wherein the flat portion of the warming surface of the first warming plate contacts the flat portion of the warming surface of the second warming plate when each of the first and second warming plates contains a pre-baked waffle and the sandwich press is pressed into the closed warming position.

2. The waffle sandwich press apparatus of claim 1, wherein the floor of the baked waffle mold is inset from the flat portion a distance between 60% and 70% of the waffle height.

3. The waffle sandwich press apparatus of claim 1, wherein the baked waffle mold forms a shape of one of a heart, an animal or a cartoon character.

4. The waffle sandwich press apparatus of claim 1, wherein the baked waffle mold comprises ridges extending from a floor of the baked waffle mold.

5. The waffle sandwich press apparatus of claim 4, wherein the ridges interlock with the pre-baked waffle.

6. The waffle sandwich press apparatus of claim 1, wherein the first and second warming plates contain the same pre-baked waffle wrapped in a burrito style.

7. The waffle sandwich press apparatus of claim 1, wherein the first warming plate contains a first pre-baked waffle and the second warming plate contains a second pre-baked waffle.

8. A waffle sandwich press apparatus comprising:
a pair of sandwich warming plates, wherein a first sandwich warming plate of the pair of sandwich warming plates is hingedly coupled to a second sandwich warming plate of the pair of sandwich warming plates, and wherein each sandwich warming plate comprises:
a waffle mold, the waffle mold having a grid pattern comprising a set of ridges, each ridge in the set of ridges extending from a floor of each of the waffle molds, wherein the ridges interlock with a waffle having a waffle height; and
the floor of each of the waffle molds inset into one of the pair of sandwich warming plates a depth equal to at least 60% of the waffle height; and
wherein a perimeter of the waffle mold formed in the first sandwich warming plate contacts a perimeter of the waffle mold formed in the second sandwich warming plate when the pair of sandwich warming plates are hinged closed.

9. The waffle sandwich press apparatus of claim 8, wherein the waffle mold forms the shape of a face and the ridges comprise facial features.

10. The waffle sandwich press apparatus of claim 8, wherein the perimeters of the waffle molds substantially form a shape of one of a square, circle, rectangle or animal.

11. The waffle sandwich press apparatus of claim 8, wherein the floor of each of the waffle molds is inset into one of the pair of sandwich warming plates a depth equal to between 60% and 70% of the waffle height.

12. The waffle sandwich press apparatus of claim 8, wherein edges of the waffle are sealed when the sandwich warming plates are hinged closed.

13. The waffle sandwich press apparatus of claim 8, further comprising a waffle maker comprising a pair of baking plates, wherein the pair of baking plates together form an impression of the waffle.

14. A method of making a pressed waffle sandwich comprising:
heating a waffle sandwich press, the waffle sandwich press comprising:
a bottom waffle mold formed in a bottom baked-waffle sandwich press plate, wherein a first depth of the bottom waffle mold is a least 60% of a first height of a first baked waffle;
a top waffle mold formed in a top baked-waffle sandwich press plate, wherein a second depth of the top waffle mold is at least 60% of a second height of a second baked waffle;
a hinge coupling the top waffle mold and the bottom waffle mold;
placing the first baked waffle into the bottom waffle mold;
setting a waffle sandwich filling on top of the first baked waffle;
positioning the second baked waffle on top of the waffle sandwich filling;
closing the top baked-waffle sandwich press plate such that the top waffle mold interlocks with the second baked waffle;
pressing down on the top baked-waffle sandwich press plate such that a first flat portion of the top baked-waffle sandwich press plate and a second flat portion of the bottom baked-waffle sandwich press plate meet and at least 60% of a shape of each of the first and second baked waffle is preserved;
wherein one of the heat, the pressure or a combination thereof seals an edge of the first baked waffle to an edge of the second baked waffle with the waffle sandwich filling therebetween, thereby forming a baked-waffle sandwich.

15. The method of claim 14, wherein the second baked waffle is the same waffle as first baked waffle and the waffle is folded over.

16. The method of claim 14, wherein the first baked waffle is distinct from the second baked waffle.

17. The method of claim 14, wherein the waffle sandwich filling comprises a third baked waffle.

18. The method of claim 14, wherein the waffle sandwich filling comprises cheese and the cheese at least partially seals the edge of the first baked waffle to the edge of the second baked waffle when melted.

19. The method of claim 14, wherein the first baked waffle and the second baked waffle are shaped in the form of one of a rectangle, circle, face, heart, square or animal.

20. The method of claim 14, wherein between 60% and 70% of the shape of each of the first and second baked waffle is preserved.

21. The method of claim 14, wherein the first height of the first baked waffle is the same as the second height of the second baked waffle.

22. The method of claim 14, wherein the first height of the first baked waffle is distinct from the second height of the second baked waffle.
